(19) United States
(12) Patent Application Publication
(10) Pub. No.: US 2016/0141644 A1
(43) Pub. Date: May 19, 2016

(54) FUEL CELL SYSTEM

(71) Applicant: TOYOTA JIDOSHA KABUSHIKI KAISHA, Toyota-shi (JP)

(72) Inventors: Shuji NAGANO, Toyota-shi (JP); Yuichi YAGAMI, Kuwana-shi (JP)

(73) Assignee: TOYOTA JIDOSHA KABUSHIKI KAISHA, Toyota-shi (JP)

(21) Appl. No.: 14/934,518

(22) Filed: Nov. 6, 2015

(30) Foreign Application Priority Data
Nov. 14, 2014 (JP) 2014-232046

(51) Int. Cl. H01M 8/04

(52) U.S. Cl. CPC H01M 8/04; H01M 2250/20

(57) ABSTRACT

An object is to provide a technique that removes a liquid entering between an auxiliary machinery cover and a cover provided to cover the auxiliary machinery cover. A fuel cell system comprises a first cover that is configured to contain an auxiliary machine for a fuel cell, and a second cover that is configured to cover at least part of a side surface and part of a bottom surface of the first cover. The second cover has an outlet that is formed in at least part of a bottom of the second cover to allow for flow of a liquid. An upper surface of the first cover is inclined downward toward the side surface of the first cover.

### CROSS REFERENCE TO RELATED APPLICATION

The present application claims priority from Japanese patent application P2014-232046 filed on Nov. 14, 2014, the entirety of disclosure of which is hereby incorporated by reference into this application.

### BACKGROUND

1. Field

The present invention relates to a fuel cell system.

2. Related Art

A fuel cell is provided with auxiliary machines such as a hydrogen pump, a sensor and a valve. In order to protect such auxiliary machines from foreign substances such as water and stones, the auxiliary machines are generally contained in and covered by an auxiliary machinery cover (for example, JP 2013-004352A).

For the purpose of suppressing transmission of noises and vibrations produced by such auxiliary machines to the outside, the surface of the auxiliary machinery cover may be further covered with another cover. A liquid is, however, likely to enter between this cover and the auxiliary machinery cover. This may result in deterioration of at least the auxiliary machinery cover. There is accordingly a need for a technique that removes the liquid entering between this cover and the auxiliary machinery cover.

### SUMMARY

In order to solve at least part of the above problems, the invention may be implemented by any of the following aspects.

(1) According to one aspect of the invention, there is provided a fuel cell system. The fuel cell system has a first cover that is configured to contain an auxiliary machine for a fuel cell and a second cover that is configured to cover at least part of a side surface and part of a bottom surface of the first cover, wherein the second cover has an outlet that is formed in at least part of a bottom of the second cover to allow for flow of a liquid, and an upper surface of the first cover is inclined downward toward the side surface of the first cover. In the fuel cell system of this aspect, the upper surface of the first cover is inclined downward. This configuration causes the liquid entering between the first cover and the second cover to be flowed downward and thereby enables the liquid to be discharged from the outlet.

(2) According to one embodiment of the fuel cell system of the above aspect, the bottom of the second cover has a surface arranged to face the first cover and inclined downward toward the outlet. This configuration enables the liquid entering between the first cover and the second cover to be more efficiently discharged from the outlet, compared with a configuration that the surface of the bottom of the second cover arranged to face the first cover is not inclined.

(3) According to one embodiment of the fuel cell system of the above aspect, the first cover may have a hole that is formed to pass through the first cover, the fuel cell system further comprising a third cover that is configured to cover the hole, wherein the third cover has an external surface that is formed flat and an internal surface that has ribs. This configuration provides the third cover with rigidity, while suppressing accumulation of the liquid on the external surface of the third cover.

The invention may be implemented by any of various aspects other than the aspects of the fuel cell system described above, for example, a method of manufacturing the fuel cell system, a computer program configured to implement the manufacturing method and a non-transitory storage medium in which such a computer program is stored.

### BRIEF DESCRIPTION OF DRAWINGS

FIG. 1 is an external view illustrating a fuel cell system according to one embodiment of the invention;

FIG. 2 is a diagram schematically illustrating external surfaces of an auxiliary machinery cover;

FIG. 3 is an external view illustrating the fuel cell system viewed downward from the upper side of the vehicle (positive Y-axis direction side);

FIG. 4 is a sectional view illustrating an A-A section of FIG. 3;

FIG. 5A is a diagram illustrating an external surface of a service hole cover; and

FIG. 5B is a diagram illustrating an internal surface of the service hole cover.

### DESCRIPTION OF EMBODIMENTS

### A. Embodiment

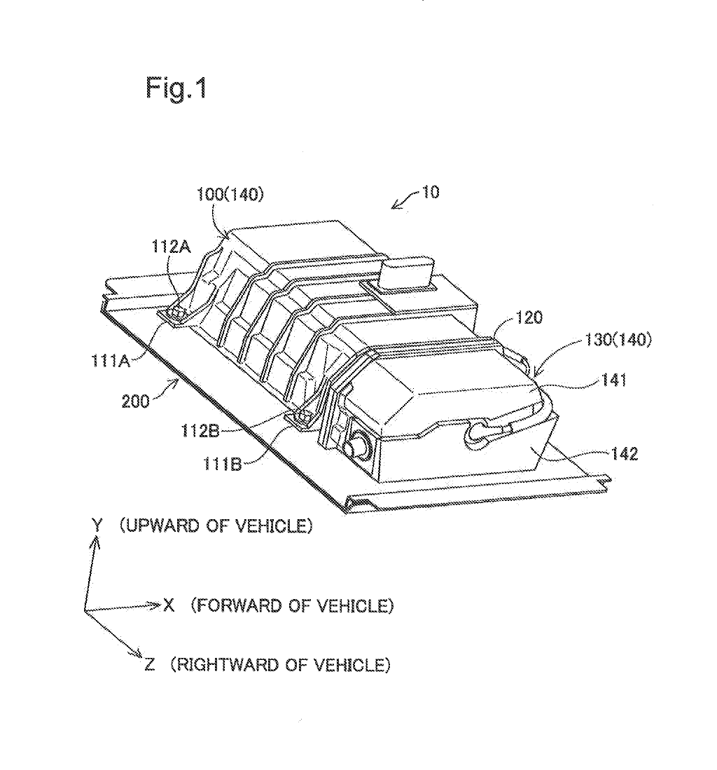

FIG. 1 is an external view illustrating a fuel cell system 10 according to one embodiment of the invention. The fuel cell system 10 includes a fuel cell system casing 140 and a frame 200. The fuel cell system 10 is mounted on a vehicle. According to this embodiment, the fuel cell system 10 is located below a vehicle interior where a driver is placed. In FIG. 1, a positive X-axis direction represents a vehicle forward direction, a positive Y-axis direction represents a vehicle upward direction, and a positive Z-axis direction represents a vehicle rightward direction.

The fuel cell system casing 140 includes a fuel cell casing 100 and an auxiliary machinery cover 130, in order to protect inside of the fuel cell system casing 140 from foreign substances such as water and dust, gaskets are provided to seal between the fuel cell casing 100 and the auxiliary machinery cover 130 and between various other components of the fuel cell system casing 140.

The fuel cell casing 100 contains a fuel cell. An electrochemical reaction of hydrogen gas as an anode gas with oxygen gas as a cathode gas proceeds in the fuel cell. The fuel cell is configured by stacking a plurality of unit cells and is mounted on the vehicle such that the stacking direction is identical with the vehicle width direction.

The fuel cell casing 100 includes a plate-like manifold 120 provided to cover a side surface of the fuel cell on the right side of the vehicle (positive Z-axis direction side), a stack casing provided to cover an upper surface and remaining side surface of the fuel cell other than the side surface on the right side of the vehicle (positive Z-axis direction side), and a lower cover (not shown) provided to cover a bottom surface of the fuel cell. The manifold 120 is configured to form a flow path of hydrogen gas, a flow path of oxygen gas and a flow path of cooling water used for cooling down the fuel cell. The manifold 120 also serves to ensure insulation to high-voltage components in the fuel cell casing 100 and to compress the unit cells against one another.

The frame 200 is placed below the fuel cell system casing 140 to fix the fuel cell system casing 140. More specifically, the frame 200 fixes the fuel cell system casing 140 by inserting bolts 112A and 112B in bosses 111A and 111B formed in the fuel cell casing 100 of the fuel cell system casing 140. There are other bosses and bolts (not shown) on the front side of the vehicle (positive X-axis direction side). In order to reduce vibrations, a rubber vibration insulator is provided, between the fuel cell system casing 140 and the frame 200. The frame 200 is clamped to a vehicle body (not shown).

The auxiliary machinery cover 130 contains a plurality of auxiliary machines (not shown) used for the fuel cell. The plurality of auxiliary machines include, for example, a hydrogen pump, an injection, an exhaust and drain valve, a valve and a sensor. The auxiliary machinery cover 130 is provided with other than the auxiliary machines, a piping for cooling water and wirings for supplying electric power to the respective auxiliary machines. The “auxiliary machinery cover 130” corresponds to the “first cover”.

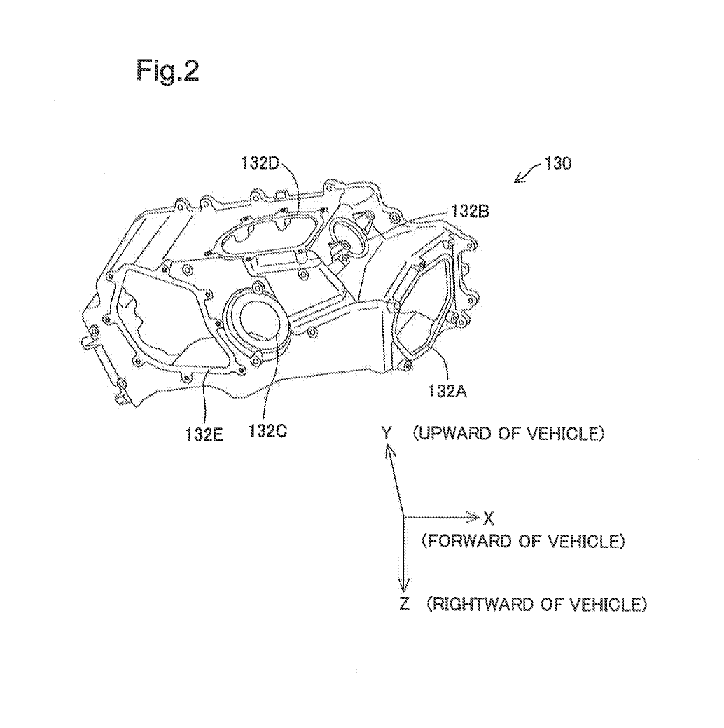

FIG. 2 is a diagram schematically illustrating external surfaces of the auxiliary machinery cover 130. XYZ axes in FIG. 2 and in subsequent drawings correspond to the XYZ axes in FIG. 1. The auxiliary machinery cover 130 is formed by aluminum die casting, which keeps the strength of the auxiliary machinery cover 130.

The auxiliary machinery cover 130 has a plurality of holes 132 (132A to 132E) formed to pass through the auxiliary machinery cover 130. The hole 132A is provided to receive a gas piping for the fuel cell. The holes 132B and 132C are provided to receive wirings. The holes 132D and 132E are provided as service holes used for connection of wirings.

According to this embodiment, the plurality of auxiliary machines are fixed to the manifold 120 (shown in FIG. 1). A side surface of the auxiliary machinery cover 130 on the left side of the vehicle (negative Z-axis direction side) is covered by the manifold 120.

The surfaces of the auxiliary machinery cover 130 are covered by NV (noise vibration)-suppressing covers 141 and 142 (as shown in FIG. 1), in order to suppress transmission of vibrations and noises produced by the auxiliary machines to the outside. The NV-suppressing covers 141 and 142 are provided to cover at least part of a side surface and part of a bottom surface of the auxiliary machinery cover 130. The “NV-suppressing covers 142 and 142” correspond to the “second cover”.

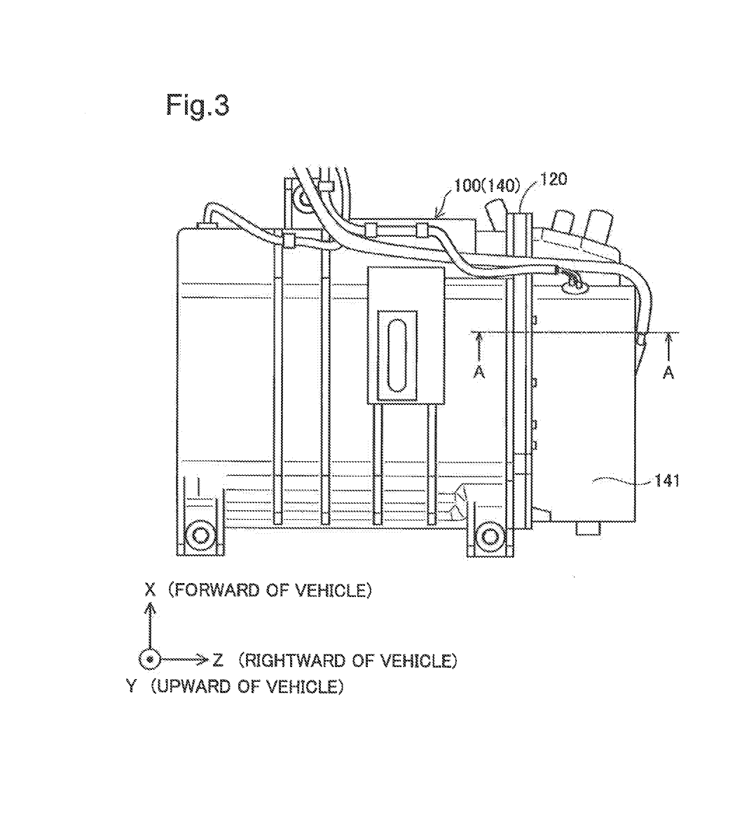

FIG. 3 is an external view illustrating the fuel cell system 10 viewed downward from the upper side of the vehicle (positive Y-axis direction side).

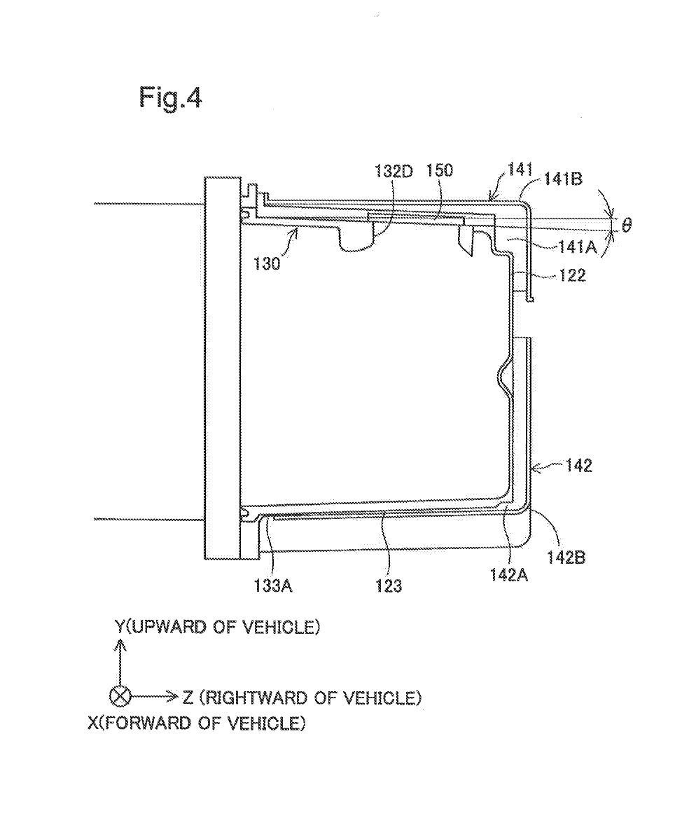

FIG. 4 is a sectional view illustrating an A-A section of FIG. 3. The NV-suppressing cover 141 has an outer layer 141B that is made of a hard resin and an inner layer 141A that is made of urethane foam. Similarly, the NV-suppressing cover 142 has an outer layer 142B that is made of a hard resin and an inner layer 142A that is made of urethane foam. The hole 132D of the auxiliary machinery cover 130 is covered by a service hole cover 150.

As shown in FIG. 4, an upper surface of the auxiliary machinery cover 130 is inclined downward toward the side surface of the auxiliary machinery cover 130. More specifically, the upper surface of the auxiliary machinery cover 130 is inclined downward to the horizontal direction by an angle θ. According to this embodiment, the angle θ is a predetermined angle in the range of 1 degree to 3 degrees. The NV-suppressing cover 142 has an outlet 133A that is formed in at least part of a bottom 123 to allow for the flow of a liquid. The following describes the upper surface, the bottom surface and the side surface of the auxiliary machinery cover 130 more specifically. The upper surface denotes a surface that is extended along the horizontal direction and located above the auxiliary machines in the state that the auxiliary machinery cover 130 contains the auxiliary machines. The bottom surface denotes a surface that is extended along the horizontal direction and is located below the auxiliary machines in the state that the auxiliary machinery cover 130 contains the auxiliary machines. The side surface is a surface that is extended along the vertical direction and is arranged to face the auxiliary machines. The surface extended along the horizontal direction includes a surface extended in a direction including a horizontal direction component. Similarly the surface extended along the vertical direction includes a surface extended in a direction including a vertical direction component. In other words, each surface may be inclined, may be curved and may have non-uniform thickness.

The liquid herein includes, for example, water produced in the fuel cell, muddy water from outside of the vehicle, and a liquid containing an antifreezing agent. According to this embodiment, the auxiliary machinery cover 130 is made of aluminum and is accordingly deteriorated especially by the presence of the antifreezing agent on the surface of the auxiliary machinery cover 130.

According to this embodiment, however, the upper surface of the auxiliary machinery cover 130 is inclined downward toward the side surface of the auxiliary machinery cover 130 as described above. This configuration causes the liquid entering between the auxiliary machinery cover 130 and the NV-suppressing covers 141 and 142 to be flowed downward from the upper surface. The NV-suppressing cover 142 also has the outlet 133A, so that the liquid flowing on the side surface is discharged from the outlet 133A.

Additionally, a surface of the bottom 123 of the NV-suppressing cover 142 arranged to face the auxiliary machinery cover 130 is inclined toward the outlet 133A. This configuration enables the liquid entering between the auxiliary machinery cover 130 and the NV-suppressing covers 141 and 142 to be more efficiently discharged from the outlet 133A, compared with a configuration that the surface of the bottom 128 arranged to face the auxiliary machinery cover 130 is not inclined.

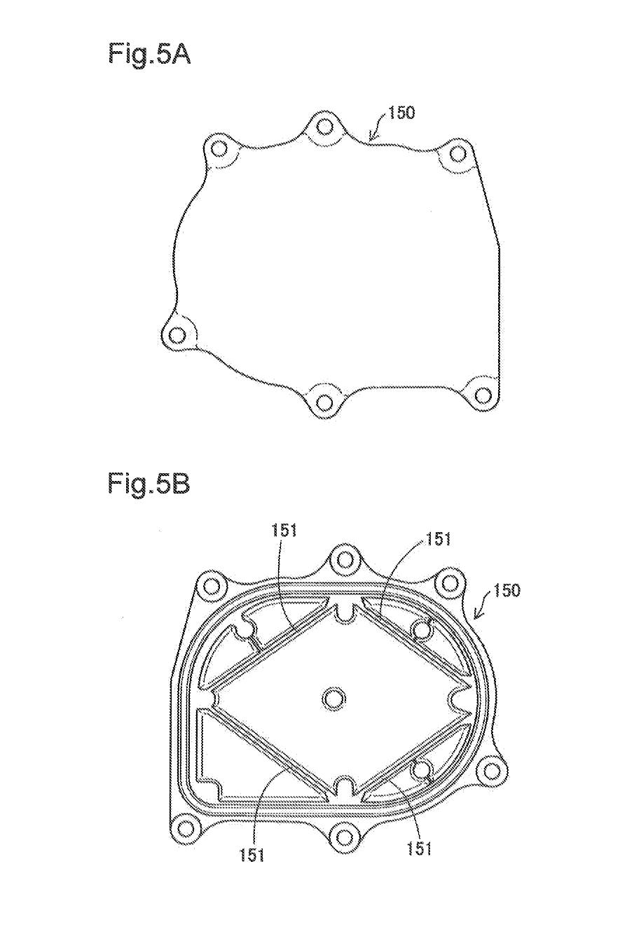

FIGS. 5A and 5B are diagrams illustrating the service hole cover 150 provided to cover the service hole or more specifically the hole 132D of the auxiliary machinery cover 130. FIG. 5A is a diagram illustrating an external surface of the service hole cover 150, and FIG. 5B is a diagram illustrating an internal surface of the service hole cover 150.

The external surface of the service hole cover 150 is formed flat to suppress accumulation of the liquid on the external surface of the service hole cover 150. The internal surface of the service hole cover 150, on the other hand, has ribs 151 to provide the service hole cover 150 with rigidity. The “service hole cover 150” corresponds to the “third cover”,

### B. Modifications

### B1. Modification 1

The NV-suppressing cover is comprised of two components 141 and 142 according to the above embodiment. This configuration is, however, not restrictive. The NV-suppressing cover may be provided as an integral single component or may be comprised of three or more components.

### B2. Modification 2

The outlet 133A is provided on the left side of the vehicle (negative Z-axis direction side) according to the above embodiment. This configuration is, however, not restrictive. The outlet 133A may be provided on the right side of the vehicle (positive Z-axis direction side).

### B3. Modification 3

According to the above embodiment, the upper surface of the bottom 123 of the NV-suppressing cover 142 is inclined downward toward the outlet 133A. The upper surface of the bottom 123 of the NV-suppressing cover 142 may, however, be not inclined or may be inclined in an opposite direction to the outlet 133A.

The invention is not limited to any of the embodiments, the examples and the modifications described above but may be implemented by a diversity of other configurations without departing from the scope of the invention. For example, the technical features of any of the embodiments, examples and modifications corresponding to the technical features of each of the aspects described in Summary may be replaced or combined appropriately, in order to solve part or all of the problems described above or in order to achieve part or all of the advantageous effects described above. Any of the technical features may be omitted appropriately unless the technical feature is described as essential herein.

What is claimed is:

1. A fuel cell system, comprising:
a first cover that is configured to contain an auxiliary machine for a fuel cell; and
a second cover that is configured to cover at least part of a side surface and part of a bottom surface of the first cover, wherein
the second cover has an outlet that is formed in at least part of a bottom of the second cover to allow for flow of a liquid, and
an upper surface of the first cover is inclined downward toward the side surface of the first cover.

2. The fuel cell system according to claim 1,
wherein the bottom of the second cover has a surface arranged to thee the first cover and inclined downward toward the outlet.

3. The fuel cell system according to claim 1,
wherein the first cover has a hole that is formed to pass through the first cover,
the fuel cell system further comprising
a third cover that is configured to cover the hole, wherein
the third cover has an external surface that is formed flat and an internal surface that has ribs.
